(19) United States
(12) Patent Application Publication
(10) Pub. No.: US 2016/0162891 A1
(43) Pub. Date: Jun. 9, 2016

(54) Unlinkable Priced Oblivious Transfer with Rechargeable Wallets

(71) Applicant: International Business Machines Corporation, Armonk, NY (US)

(72) Inventors: Jan Camenisch, Zurich (CH); Maria Dubovitskaya, Zurich (CH); Gregory Neven, Zurich (CH)

(21) Appl. No.: 14/961,036

(22) Filed: Dec. 7, 2015

Related U.S. Application Data
(62) Division of application No. 13/574,086, filed on Jul. 19, 2012.

(30) Foreign Application Priority Data
Jan. 22, 2010 (EP) 1015389.3

(51) Int. Cl. G06Q 20/40; G06Q 20/36

(52) U.S. Cl. CPC G06Q 20/401; G06Q 20/367; G06Q 2220/00

(57) ABSTRACT

A protocol that allows customers to buy database records while remaining fully anonymous, i.e. the database server does not learn who purchases a record, and cannot link purchases by the same customer; the database server does not learn which record is being purchased, nor the price of the record that is being purchased; the customer can only obtain a single record per purchase, and cannot spend more than his account balance; the database server does not learn the customer's remaining balance. In the protocol customers keep track of their own balances, rather than leaving this to the database server. The protocol allows customers to anonymously recharge their balances.

### CROSS REFERENCE TO RELATED APPLICATION

This is a divisional of pending U.S. patent application Ser. No. 13/574,086, filed Jul. 19, 2012, entitled “Unlinkable Priced Oblivious Transfer with Rechargeable Wallets”, which is herein incorporated by reference. This application claims priority under 35 U.S.C. §120 of application Ser. No. 13/574,086.

### BACKGROUND

The present invention relates to a method for anonymously reading database records, where the records may have a different price.

Digital items are often sold by a website that charges per purchased item, and that sells different items at different prices. But there is the risk that the owners of the website are making a lucrative parallel business out of selling information about the shopping behaviour of customers. For example, this can be a problem for a pharmaceutical company that buys information about particular deoxyribonucleic acid genome sequences from a database, or for a high-tech company that buys patent documents from a patent database. The list of purchased records from either of these databases certainly reveals precious information about the company's research strategies. The question then appears, how can one prevent the database from gathering information about shopping behaviour while still allowing the database to correctly charge for the purchased items?

Network traffic obfuscation techniques like mixes and onion routing can be used to hide a network address, but do not help to hide which record is purchased. Anonymous payment systems are not very useful here because they require that the merchant knows the price of the item, which may already reveal too much information about the item.

As a solution to this problem it was proposed to use a priced oblivious transfer protocol (POT) by W. Aiello, Y. Ishai, and O. Reingold “Priced oblivious transfer: How to sell digital goods”, Proc. of EUROYCRYPT 2001, Vol. 2045 of LNCS, pp. 119-135, Springer Verlag, 2001. Here, customers load an initial amount of money into their pre-paid accounts, and can then start downloading records so that (1) the database does not learn which record is being purchased, nor the price of the record that is being purchased; (2) the customer can only obtain a single record per purchase, and cannot spend more than his account balance; (3) the database does not learn the customer's remaining balance.

All known POT protocols require the database to maintain customer-specific state information across the different purchases by the same customer to keep track of his (encrypted) account balance. Each customer's transactions thereby necessarily become linkable. Thus, none of these protocols allow the customer to purchase records anonymously: even if an anonymous payment system is used to pre-charge the initial balance, the customer could be at most pseudonymous, defeating the purpose of protecting the customer's privacy. For example, the database still learns the number of records bought by each customer, the time that these records were bought, and their average price. This clearly reveals information about the customer and might lead to identification of the customer or of the records he is buying. To overcome this, it is further required that the POT satisfy that (4) the database does not learn any information about who purchases a record. Existing POT protocols also lack recharge functionality: Once a customer's balance does not contain enough credit to buy a record, but is still positive, the customer cannot use up the balance, but will have to open a new account/balance for further purchases.

### SUMMARY

According to one embodiment of the present invention, a computer system is described comprising:
a database server comprising publishing means to publish an encrypted form of a database, the database comprising at least one record with an associated index and its price, the publishing means being responsive to database encryption means, the database encryption means comprising:
   key generation means to generate a record encryption key for a record such that the record encryption key is derived from at least the index of the record and a secret key of the database server;
   record encryption means responsive to the key generation means to encrypt a record with the record encryption key;
at least one customer of the database server;
   and
the key generation means being adapted such that the record encryption key is also derived from the price of the record;
the database server further comprising:
   wallet registering means to register an empty wallet, the wallet registering means being responsive to a wallet creation request from a customer;
   wallet recharging means responsive to a wallet received from a customer to accept a recharged wallet;
purchasing means responsive to a wallet and an encrypted record received from a customer to decrypt the encrypted record when the wallet was rebalanced by the price of the record after its registration.

According to another embodiment of the present invention, a method and a corresponding computer program and a corresponding computer program product for anonymously reading records from a database provided by a database server is described, wherein the database comprises at least one record with an associated index and price and wherein the database provider publishes an encrypted form of the database, and wherein for each record contained in the encrypted form of the database the following steps are performed:
generating a record encryption key that is derived at least from the index of the record and a secret key of the database server;
encrypting the record with the record encryption key;
   and
the generating step being adapted such that the record encryption key is also derived from the price of the record;
in response to a request from a customer registering an empty wallet;
in response to a recharged wallet provided by a customer accepting the rebalanced wallet;
in response to a purchase request with a wallet and encrypted record submitted by a customer decrypting the encrypted record when the wallet is rebalanced by the price of the record.

### BRIEF DESCRIPTION OF THE SEVERAL VIEWS OF THE DRAWINGS

FIG. 1: Is a block diagram illustrating a system in accordance with the present invention;

FIG. 2: Is a description of a database setup algorithm in accordance with the present invention;

FIG. 3: Is a flow diagram illustrating a database setup algorithm in accordance with the present invention;

FIG. 4: Is a description of a wallet creation algorithm in accordance with the present invention;

FIG. 5: Is a flow diagram illustrating the customer's side of the wallet creation algorithm from FIG. 3;

FIG. 6: Is a flow diagram illustrating the database server side of the wallet creation algorithm from FIG. 3;

FIG. 7: Is a description of a wallet recharge algorithm in accordance with the present invention;

FIG. 8: Is a flow diagram illustrating the database server side of the wallet recharge algorithm from FIG. 7;

FIG. 9: Is a flow diagram illustrating the customer's side of the wallet recharge algorithm from FIG. 7;

FIG. 10: Is a description of a purchase algorithm in accordance with the present invention;

FIG. 11: Is a flow diagram illustrating the customer's side of the purchase algorithm from FIG. 10;

FIG. 12: Is a flow diagram illustrating the database server side of the purchase algorithm from FIG. 10;

FIG. 13: Is a block diagram of a system in which certain embodiments may be implemented.

### DETAILED DESCRIPTION

### Construction Overview

Each record may have a different price in the database. The database server encrypts each record with a key that is derived from not only its index but also its price and then publishes the whole encrypted database. To be able to access records, a customer as a user of the database first contacts the database server to create a new, empty wallet. Customers can load more money into their wallet at any time. The payment mechanism used to recharge customers' wallets can be implemented using prior art methods. But for full customer anonymity, an anonymous e-cash scheme is preferable. When a customer wants to purchase a record with index σ with price p from the database, the database server and the customer essentially run a two party protocol at the end of which the customer will have obtained the decryption key for the record as well as an updated wallet being worth p monetary units less. This is done is such a way that the provider does not learn anything about σ or p. More precisely, wallets are modelled as one-time-use anonymous credentials with the worth of the wallet being encoded as an attribute. When the customer buys a record (or charges her wallet), he basically uses the credential and gets in exchange a new credential with the updated worth as attribute without the server learning anything about the wallet's worth. The properties of onetime-use credentials ensure that a customer cannot buy records worth more than what he has (pre-)paid to the server.

### Theoretical Preliminaries

If ?∈ [symbol] , then 1^{κ} is the string consisting of κ ones. The empty string is denoted ε. If A is a randomized algorithm, then

$$y {←}^{\$} A ( x )$$

denotes the assignment to Y of the output of A on input x when run with fresh random coins. Unless noted, all algorithms are probabilistic polynomial-time (PPT) and it is implicitly assumed that they take an extra parameter 1^{κ} in their input, where κ is a security parameter. A function ν: [symbol] →[0,1] is negligible if for all c∈ [symbol] there exists a κ_{c}∈ [symbol] such that ν(κ)<κ^{-c} for all κ>κ_{c}.

Let Pg(1^{κ}) be a pairing group generator that on input 1^{κ} outputs descriptions of multiplicative groups [symbol] , [symbol] _{T} of prime order p where |p|>κ. Let Pg(1^{κ}) be a pairing group generator that on input p outputs descriptions of multiplicative groups [symbol] , [symbol] _{T} of prime order p. Let [symbol] *= [symbol] _{T}\{1} and let g∈ [symbol] *. The generated groups are such that there exists an admissible bilinear map e: [symbol] × [symbol] → [symbol] _{T}, meaning that (1) for all a,b∈ [symbol] ₚ it holds that e(g^{a}, g^{b})=e(g, g)^{ab}, (2) e(g,g)≠1; and (3) the bilinear map is efficiently computable.

Definition: We say that the l-power decision Diffie-Hellman ( [symbol] -PDDH) assumption [see J. Camenisch, G. Neven, and Abhi Shelat “Simulatable adaptive oblivious transfer”, Proc. of EUROCRYPT 2007, vol. 4515 of LNCS, pp. 573-590, Springer Verlag 2007] holds in groups Γ,Γ_{T} if for all polynomial-time adversaries A the advantage Adv_{Γ,Γ}_{_{T}}^{PDDH}(κ) is given by

Pr└A(g,g^{α}, . . . ,g^{α}^{^{l}},H,H^{α}, . . . ,H^{α}^{^{l}})=1┘−Pr└A(g,g^{α}, . . . ,g^{α}^{^{l}},H₀, . . . ,Hₗ)=1┘

is a negligible function in κ, where

$$g {←}^{\$} {Γ}^{*} , {H}_{0} , … , {H}_{l} {←}^{\$} {Γ}_{T}^{*} and α {←}^{\$} {ℤ}_{p} .$$

Definition: We say that the l-strong Diffie-Hellman ( [symbol] -SDH) assumption holds in group Γₗ of order p>2^{κ} if for all polynomial-time adversaries A the advantage

$${Adv}_{{Γ}_{1}}^{S D H} ( κ ) = Pr [ A ( g , {g}^{x} , … , {g}^{{x}^{l}} ) = ( c , {g}^{\frac{1}{x + c}} ) ]$$

is a negligible function in κ, where Pr is the probability,

$$g {←}^{\$} {Γ}_{1}^{*} and x , c {←}^{\$} {ℤ}_{p} .$$

The following modification of the weakly-secure signature scheme from D. Boneh and X. Boyen “Short signatures without random oracles”, Proc. of EUROCRYPT 2004, vol. 3027 of LNCS, pp. 56-73, Spinger Verlag 2004, is used. The scheme uses a pairing generator Pg as defined above. The signer's secret key is

$$( {x}_{m} , {x}_{1 ,} … , {x}_{l} ) {←}^{\$} {ℤ}_{p} ,$$

the corresponding public key is (g, yₘ=g^{x}^{ₘ}, y₁=g^{x}^{₁}, . . . , yₗ=g^{x}^{ₗ}) where g is a random generator of 9₁. The signature on the tuple of messages (m, c₁, . . . , cₗ) is

$$s ← {g}^{\frac{1}{{x}_{m} + m + {x}_{1} {c}_{1} + … + {x}_{l} {c}_{l}}} ;$$

verification is done by checking whether e(s,yₘ·g^{m}·y₁^{c}^{ₗ}· . . . ·yₗ^{c}^{ₗ})=e(g,g) is true.

Security against weak chosen message attacks is defined through the following game. An adversary begins by outputting N tuples of messages ((m₁, c_{1,1}, . . . , c_{1,l}), . . . , (m_{N}, c_{N,1}, . . . , c_{N,l})). A challenger then generates the key pair and gives the public key to the adversary, together with signatures s₁, . . . , s_{N} on the message tuples. The adversary wins if it succeeds in outputting a valid signature S on a tuple (m, c₁, . . . , cₗ)∉{(m₁, c_{1,1}, . . . , c_{1,l}), . . . (m_{N}, c_{N,1}, . . . , c_{N,l})}. This scheme is said to be unforgeable under weak chosen-message attack if no PPT adversary has non-negligible probability of winning this game. An adaptation of the proof by Boneh and Boyen can be used to show that this scheme is unforgeable under weak chosen message attack if the (N+1)-SDH assumption holds.

Definitions from the following articles are used in the following: M. H. Au, W. Susilo, and Y. Mu “Constant-size dynamic k-TAA”, Proc. of SCN 06, vol. 4116 of LNCS, pp. 111-125, Springer Verlag 2006; and R. Cramer, I. Damgård, and P. D. MacKenzie “Efficient zero-knowledge proofs of knowledge without intractability assumptions”, Proc. of PKC 2000, vol. 1751 of LNCS, pp. 354-372, Springer Verlag 2000. A pair of interacting algorithms (P,V) is a proof of knowledge (PoK) for a relation R={(α,β)}⊂{0,1}*×{0,1}* with knowledge error κε[0,1] if (1) for all (α,β)∈R, V(α) accepts a conversation with P(β) with probability 1; and (2) there exists an expected polynomial-time algorithm E, called the knowledge extractor, such that if a cheating prover \hat{P} has probability ε of convincing V to accept α, then E, with a given rewindable black-box access to \hat{P}, outputs a witness β for with probability ε−κ.

A proof system (P,V) is perfect zero-knowledge if there exists a PPT algorithm Sim, called the simulator, such that for any polynomial-time cheating verifier \hat{V} and for any (α,β)∈R, the output of \hat{V}(α) after interacting with P(β) and the output of Sim^{\hat{V}(α)}(α) are identically distributed. A Σ-protocol is a proof system (P,V) where the conversation is of the form (a,c,z), where a and z are computed by P, and c is a challenge chosen at random by V. The verifier accepts if φ(α,a,c,z)=1 for some efficiently computable predicate φ. Given two accepting conversations (a,c,z) and (c,c′,z′) for c≠c′, one can efficiently compute a witness β. Moreover there exists a polynomial-time simulator Sim that on input α and a random string c outputs an accepting conversation (a,c,z) for α that is perfectly indistinguishable from a real conversation between P(β) and V(α).

For a relation R={(α,β)} with Σ-protocol (P,V), the commitment relation R′={(α,a), (c,z)} holds if φ(α,a,c,z)=1. If both R and R′ have i-protocols, then Cramer et al. cited above show how to construct a four-move perfect zero-knowledge PoK for R with knowledge error

$$κ = \frac{1}{\vert C \vert} ,$$

where C is the space from which the challenge c is drawn.

In the common parameters model, several previously known results for proving statements about discrete logarithms are used, such as (1) proof of knowledge of a discrete logarithm modulo a prime [see C. P. Schnorr “Efficient signature generation for smart cards”, Journal of Cryptology, 4(3):239-252, 1991], (2) proof of knowledge of equality of (elements of) representations [see D. Chaum and T. P. Pedersen “Wallet databases with observers”, Proc. of CRYPTO '92, vol. 740 of LNCS, pp. 89-105, Springer Verlag 1993], (3) proof that a commitment opens to the product of two other committed values [see S. Brands “Rapid demonstration of linear relations connected by Boolean operators”, Proc. of EUROCRYPT '97, vol. 1233 of LNCS, pp. 318-333, Springer Verlag 1997; J. Camenisch, M. Michels “Proving in zero-knowledge that a number n is the product of two safe primes”, Proc. of EUROCRYPTT '99, vol. 1592 of LNCS, Springer Verlag 1999; J. Camenisch “Group Signature Schemes and Payment Systems Based on the Discrete Logarithm Problem”, PhD Thesis, ETH Zurich, 1998], and also (4) proof of the disjunction or conjunction of any two of the previous [see R. Cramer, I. Damgård, B. Schoenmakers “Proofs of partial knowledge and simplified design of witness hiding protocols”, Proc. of CRYPTO '94, vol. 839 of LNCS, pp. 174-187, Springer Verlag 1994].

When referring to the proofs above, the notation introduced by Camenisch and Stadler [“Efficient group signature schemes for large groups”, Proc. of '97, vol. 1296 of LNCS, pp. 410-424, Springer Verlag 1997] will be followed for various proofs of the validity of statements about discrete logarithms. For instance, PK{(a,b,c): y=g^{a}h^{b} [symbol] \tilde{y}=\tilde{g}^{a}h^{c}} denotes a “zero-knowledge Proof of Knowledge of integers a,b,c such that y=g^{a}h^{b} and \tilde{y}=\tilde{h}^{a}\tilde{h}^{c} holds,” where y, g, h, \tilde{y}, \tilde{g}, \tilde{h} are elements of some groups G= [symbol] g [symbol] = [symbol] h [symbol] and G= [symbol] \tilde{g} [symbol] , [symbol] \tilde{h} [symbol] . The convention is that the letters in the parenthesis denote quantities of which knowledge is being proven, while all other values are known to the verifier. The Fiat-Shamir heuristic [A. Fiat and A. Shamir “How to prove yourself; Practical solutions to identification and signature problems”, Proc. of CRYPTO '86, vol. 263 of LNCS, pp. 186-194, Springer Verlag 1987] is applied to turn such proofs of knowledge into signatures on some message m; denoted as, e.g., SPK{(a):y=g^{α}}(m).

Given a protocol in this notation, it is straightforward to derive an actual protocol implementing the proof [see the PhD Thesis of Camenisch cited above and J. Camenisch, A. Kiayias, M. Yung “On the portability of generalized schnorr proofs”, Proc. of EUROCRYPT 2009, LNCS, Springer Verlag 2009]. Indeed, the computational complexities of the proof protocol can be easily derived from this notation: basically for each term y=g^{a}h^{b}, the prover and the verifier have to perform an equivalent computation, and to transmit one group element and one response value for each exponent.

The signature scheme proposed and proved secure by Au et al. [M. H. Au, W. Susilo, and Y. Mu “Constant-size dynamic k-TAA”, Proc. of SCN 06, vol. 4116 of LNCS, pp. 111-125, Springer Verlag 2006] is used, which is based on the schemes of Camenisch and Lysyankaya [J. Camenisch, A. Lysyanskaya “Signature schemes and anonymous credentials from bilinear maps”, Proc. of CRYPTO 2004, vol. 3152 of LNCS, pp. 56-72, Springer Verlag 1999] and of Boneh et al. [D. Boneh, X. Boyen, h. Shacham “Short group signatures”, Proc. of CRYPTO 2004, vol. 3152 of LNCS, Springer Verlag 2004]. It assumes cyclic groups Γ and Γ_{T} of order p and a bilinear map e:Γ×Γ→Γ_{T}. The signer's secret key is a random element

$$x {←}^{\$} {ℤ}_{q} .$$

The public key contains a number of random bases g₁, h₀, . . . , hₗ,

$${h}_{l + 1} {←}^{\$} Γ$$

where l∈ [symbol] is a parameter, and y←g₁^{x}.

A signature on messages m₀, . . . , mₗ∈ [symbol] _{q} is a tuple (A,r,s) where

$$r , s {←}^{\$} {ℤ}_{q}$$

are values chosen at random by the signer and

$$A = {( {g}_{1} {h}_{0}^{{m}_{0}} … {h}_{l}^{{m}_{l}} {h}_{l + 1}^{r} )}^{\frac{1}{x + s}} .$$

Such a signature can be verified by checking whether e(A, g₁^{s}y)=e(g₁h₀^{m}^{₀} . . . hₗ^{m}^{ₗ}hₗ₊₁^{r}, g₁)

Now it is assumed that a signature (A,r,s) is given on messages m₀, . . . , mₗ∈ [symbol] _{q} and that it will be proved if indeed such a signature is possessed. The public key needs to be augmented with values U, ν∈Γ such that log_{g}_{₁}u and log_{g}_{₁}ν are not known. This can be done as follows:
Choose random values

$$t , {t}^{′} {←}^{\$} {ℤ}_{q}$$

and compute Ã=Au^{t}, B=ν^{t}u^{t′};
Execute the following proof of knowledge

$$P K \{ ( α , β , s , t , {t}^{′} , {m}_{0} , … , {m}_{l} , r ) : B = {v}^{t} {u}^{{t}^{′}} ⋀ 1 = {B}^{- s} {v}^{α} {u}^{β} \\ \frac{e ( \tilde{A} , y )}{e ( {g}_{1} , {g}_{1} )} = e ( {\tilde{A}}^{- s} {u}^{α} {h}_{l + 1}^{r} {\prod }_{i = 0}^{l} {h}_{i}^{{m}_{i}} , {g}_{1} ) {e ( u , y )}^{t} \} ,$$

where α=st and β=st′.

It was proved by Au et al. cited above that the above signature is unforgeable under adaptively chosen message attack if Q-SDH assumption holds, where Q is the number of signature queries, and that the associated PoK is perfect honest-verifier zero knowledge.

### Unlinkable Priced-Oblivious Transfer

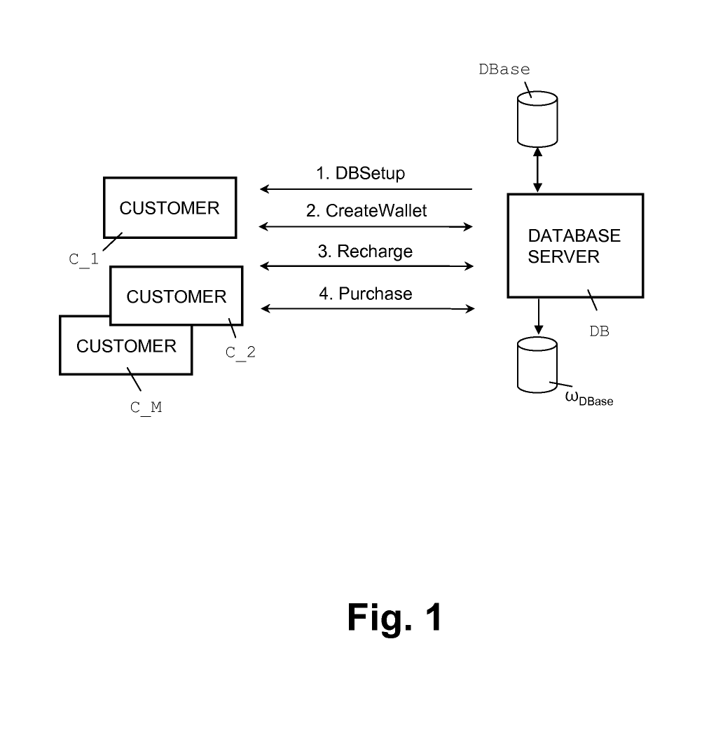

FIG. 1 shows a database server DB maintaining a database DBase, for which it is publishing an encrypted form ω_{DBase} of the database DBase, and customers C_1, C_2, . . . , C_M of the database server DB.

An unlinkable priced oblivious transfer (UP-OT) scheme is parameterized by a security parameter κ∈ [symbol] , a maximum wallet balance bₘₐₓ∈ [symbol] and a maximum record price pₘₐₓ≦bₘₐₓ. Let us consider a setting with one database and one or more customers. A database consists of a list of N couples ((R₁, p₁), . . . , (R_{N}, p_{N})), containing the database records and associated prices p₁, . . . , p_{N}. An UP-OT scheme is a tuple of polynomial-time algorithms and protocols UP-OT=(DBSetup, CreateWallet, Recharge, Purchase) run between customers C₁, . . . , C_{M}, and the database server DB in the following way:
DBSetup: DB:

$$( D B = {( {R}_{i} , {p}_{i} )}_{i = 1 , … , N} ) {\to }^{\$} ( ( p {k}_{D B} , E {R}_{1} , … , E {R}_{N} ) , s {k}_{D B} )$$

The database server DB runs the randomized DBSetup algorithm to initiate the database DBase containing its records with the associated prices. It generates a pair of a secret and corresponding public key (sk_{DB}, pk_{DB}) for the security parameter κ, and uses it to encrypt the individual records. The encrypted database ω_{DB} consists of the public key pk_{DB} and the encrypted records ER₁, . . . , ER_{N}. The encrypted database ω_{DB} is made available to all customers, e.g. by publishing it on a website or by distributing it on a storage media. The database server DB keeps the secret key sk_{DB} to himself.
CreateWallet: DB: (pk_{DB},sk_{DB})→(ε); C:(pk_{DB})→(W₀ or ⊥)

A customer creates an empty wallet with a zero balance, signed by the database server DB, by engaging in the CreateWallet protocol with the database server DB. The server's public key pk_{DB} is a common input, the corresponding secret key sk_{DB} is a secret input to the database server DB. At the end of the protocol, the customer outputs an empty wallet W₀ or ⊥ to indicate failure.
Recharge: DB: (pk_{DB}, m, sk_{DB})→(Σ); C: (pk_{DB}, m, Wᵢ)→(Wᵢ₊₁ or ⊥)

When the customer wants to add money to his wallet Wᵢ (which may or may not be his initial wallet W₀) he can engage in a Recharge protocol with the database server DB. The server's public key pk_{DB} and the amount of money that the customer wants to add to his balance are common inputs. The server's secret key sk_{DB} and the current wallet Wᵢ of the customer are private inputs to the database server DB and the customer, respectively. At the end of the protocol the customer either outputs the new wallet Wᵢ₊₁ or ⊥ to indicate failure.
Purchase: DB: (pk_{DB}, sk_{DB})→(ε); C: (pk_{DB}, σ, ER_{σ}, Wᵢ)→((⊥, Wᵢ₊₁) or (R_{σ}, ⊥) or (⊥, ⊥))

To purchase a record from the database, a customer engages in a Purchase protocol with the database server DB. The server's public key pk_{DB} is a common input. The customer has as a private input his selection index σ∈{1, . . . , N}, the encrypted record ER_{σ} and its price p_{σ}, and his current wallet Wᵢ. The server uses its secret key sk_{DB} as a private input. At the end of the protocol, the customer outputs the database record R_{σ} and an updated wallet Wᵢ₊₁. An output containing R_{σ}=⊥ or Wᵢ₊₁=⊥ indicates that the record transfer or the wallet update failed, respectively.

An oblivious transfer with access control protocol is described by J. Camenisch, M. Dubovitskaya, and G. Neven “Oblivious transfer with access control”, Proc. of the 16^{th} ACM CCS 2009, p. 131-140, ACM, 2009. In the preferred embodiment of the invention, the database server DB fulfils the role of the issuer described in this paper and issues wallets as one-time show credentials, hence also playing the role of the bank.

### The UP-OT Implementation

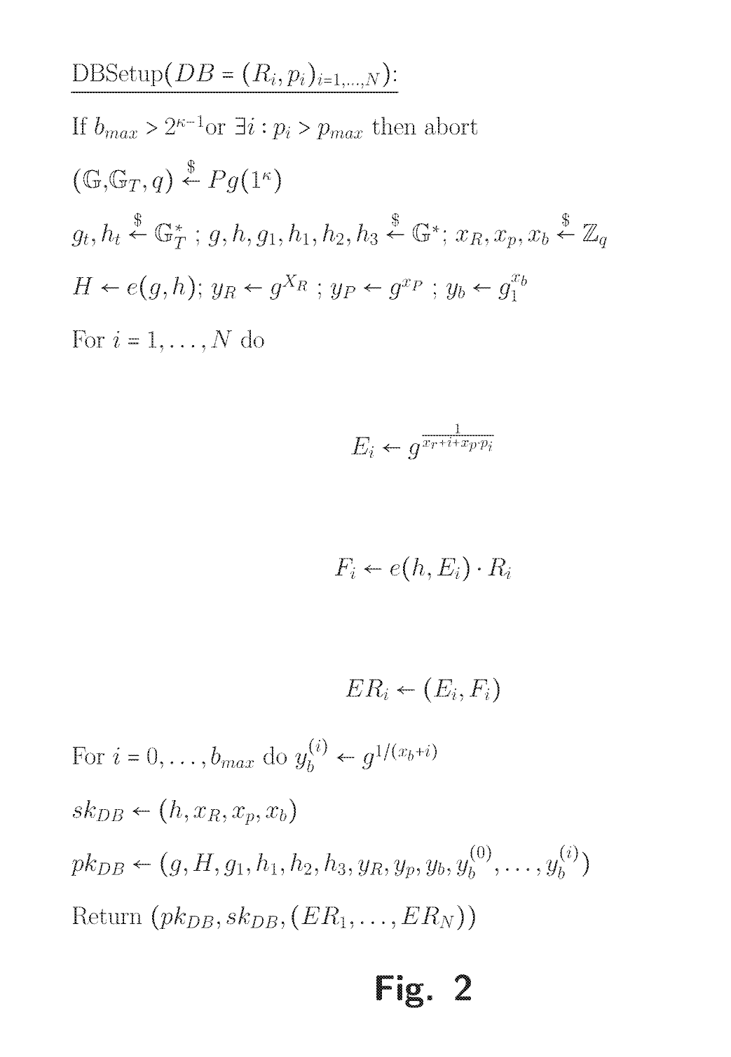

FIG. 2 shows the database setup algorithm. Customers do not have their own setup procedure. The database server DB runs the randomized DBSetup algorithm to initiate a database containing records R₁, . . . , R_{N} with corresponding prices p₁, . . . , p_{N}. Then it generates a pairing group of prime order q for security parameter κ, a number of random generators, and three secret keys x_{R}, Xₚ, x_{b} with corresponding public keys y_{R}, y_{P}, y_{b}. Intuitively, x_{R} is the seed used to generate randomness to encrypt the records, xₚ securely links prices to records, and x_{b} authenticates the balance in customers' wallets. The database server DB encrypts and signs each record Rᵢ with its own key to a ciphertext (Eᵢ, Fᵢ). These keys not only depend on the secret keys x_{R}, xₚ of the database server DB, but also on the index i and the price pᵢ of the record.

Let

$${p}_{max} \leq {b}_{max} < {2}^{κ - 1} < \frac{q}{2}$$

be the maximal balance that can be stored in a customer's wallet. To prove that the customer's new balance after buying a record remains positive and is not more than maximum balance that is used as a signature-based set membership protocol (see J. Camenisch et al “Efficient protocols for set membership and range proofs”, Proc. of ASIACRYPT 2008, Vol. 5350 of LNCS, pp. 234-252, Springer Verlag, 2008). They consider a zero-knowledge protocol which allows a prover to convince a verifier that a digitally committed value is a member of a given public set. This protocol has the verifier to produce signatures on the set elements, send them to the prover and then has the prover to show that he knows a signature (by the verifier) and the element he holds. Concretely, they employed the weak signature scheme by Boneh and Boyen cited above. They prove that their protocol is a zero-knowledge argument of set membership for a set Φ, if the |Φ|−SDH assumption holds.

Here the set contains all possible balances from the customer's wallet {0, . . . , bₘₐₓ}. So for each possible balance 0≦i≦bₘₐₓ the database provider uses x_{b} to compute a signature {y_{b}⁽ⁱ⁾}. These values are included in the public key of the database server DB; they will be used by the customer to prove that his balance remains positive after subtracting the price of the purchased record. The encrypted database consists of a public key pk_{DB} and the encrypted records ER₁, . . . , ER_{N}. It is made available to all customers, e.g. by publishing it on a website or by distributing it on a storage media. The database server DB keeps the secret key sk_{DB} to itself.

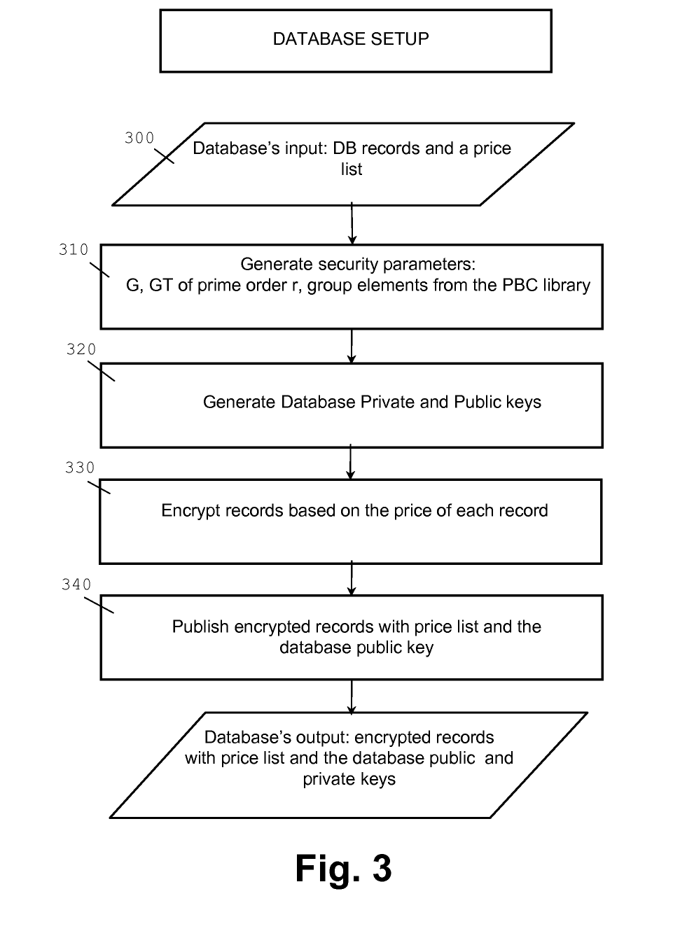

FIG. 3 shows an implementation of the database setup algorithm from FIG. 2. The database records and price list is used as input 300 of the database server DB. Then in step 310 the security parameters are generated: the groups G, GT of prime order r. The public and private keys of the database server DB are generated in step 320. The records of the database are encrypted based on the price of each record in step 330. The encrypted records and the price list are then published with the public key of the database server DB in step 340.

The database setup algorithm can be implemented using the PBC library, which is a free portable C library allowing the rapid prototyping of pairing-based cryptosystems. It provides an abstract interface to a cyclic group with a bilinear pairing, insulating the programmer from mathematical details. The following code fragment provides an example implementation for steps 310, 320, 330 using the PBC library:

//generate system parameters
element_init_G1(h, pairing); element_random(h);
element_init_G1(h1, pairing); element_random(h1);
element_init_G1(h2, pairing); element_random(h2);
element_init_G1(h3, pairing); element_random(h3);
element_init_G1(g1, pairing); element_random(g1);
element_init_GT(gT, pairing); element_random(gT);
element_init_GT(hT, pairing); element_random(hT);
pairing_pp_t ppg; pairing_pp_init(ppg, g, pairing);
pairing_pp_t pph; pairing_pp_init(pph, h, pairing);
pairing_pp_apply(H, h, ppg);

An example implementation for step 320 is given by the following code fragment:

//generate private and public keys:
//key pair for record index
element_init_Zr(xR, pairing); element_random(xR);
element_pow_zn(yR, g, xR);
//key pair for wallets and balances
element_init_Zr(xB, pairing); element_random(xB);
element_pow_zn(yB, g, xB);
//key pair for prices
element_init_Zr(xP, pairing); element_random(xP);
element_pow_zn(yP, g, xP);
//create signatures yB[ ] for all possible balances
For i=0 to b_max
{
element_pow_zn(yB[i], g, 1/(xB+i));
}
Database's Public key pkDB = (g, H, g1, h1, h2, h3, yR, yB[ ],
yP);
Database's Secret key skDB = (h, xR, xB, xP);

Step 330 can be implemented using the following code fragment:

```
//encrypt records (R[ ], PL=p[ ])
For i=1 to N
{
    x[i]=xP*p[i];
    element_pow_zn(E[i], g, xDB+i+x[i]);
    pairing_pp_apply(T[i], E[i], pph);
    F[i] = T[i]*R[i]
}
```

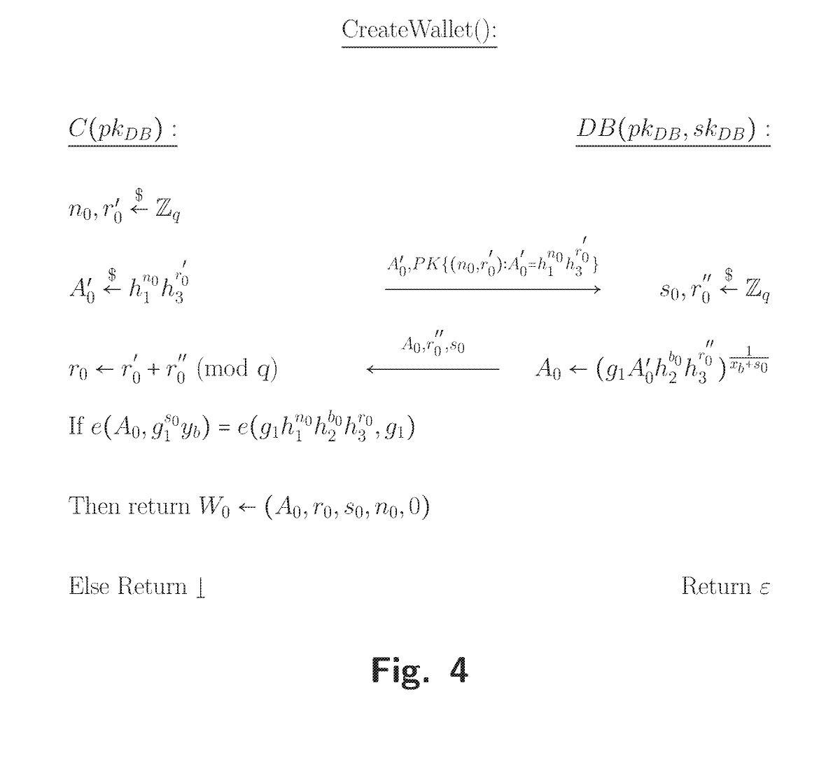

Before purchasing any records, customers first need to create an empty wallet and then charge it with money. To create a wallet, the customer runs the CreateWallet protocol with the database server DB shown in FIG. 4. The public key pk_{DB} of the database server DB is the common input. The database server DB has his secret key sk_{DB} as a private input. At the end of the protocol, the customer obtains a wallet W₀=(A₀, r₀, s₀, n₀, b₀) signed by the database server DB. Here (A₀, r₀, s₀) is essentially a signature as defined above of a serial number n₀ chosen by the customer and the initial balance of the wallet b₀=0. Next, the customer verifies the wallet's signature and outputs if the check is successful.

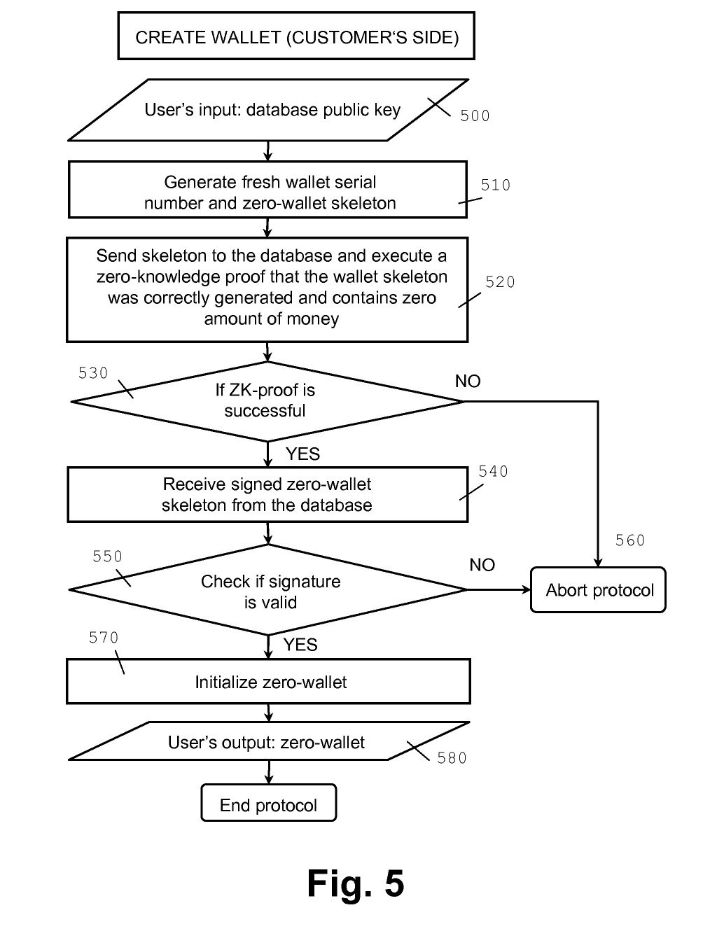

FIG. 5 shows an implementation of the customer side of the CreateWallet protocol. The public key of the database server DB is the input 500 of the customer in step 510, wherein a fresh wallet serial number and a zero-wallet skeleton are generated. The wallet skeleton is a customer generated value containing a serial number, a randomizer and its balance. The randomizer is a random value needed to hide the serial number and the balance of the wallet. The zero-wallet skeleton will be send to the database server DB in step 520 followed by the execution of a zero-knowledge proof with the database server DB that the wallet skeleton was correctly generated and contains zero amount of money. In step 530 it will be determined if the zero-knowledge proof was successful. If not, then the protocol will be aborted in step 560. Otherwise the signed zero-wallet skeleton will be received from the database server DB in step 540. Then it will be determined in step 550 if the signature is valid. If not, then the protocol aborts in step 560. Otherwise the zero-wallet will be initialized in step 570, which results in a zero wallet 580.

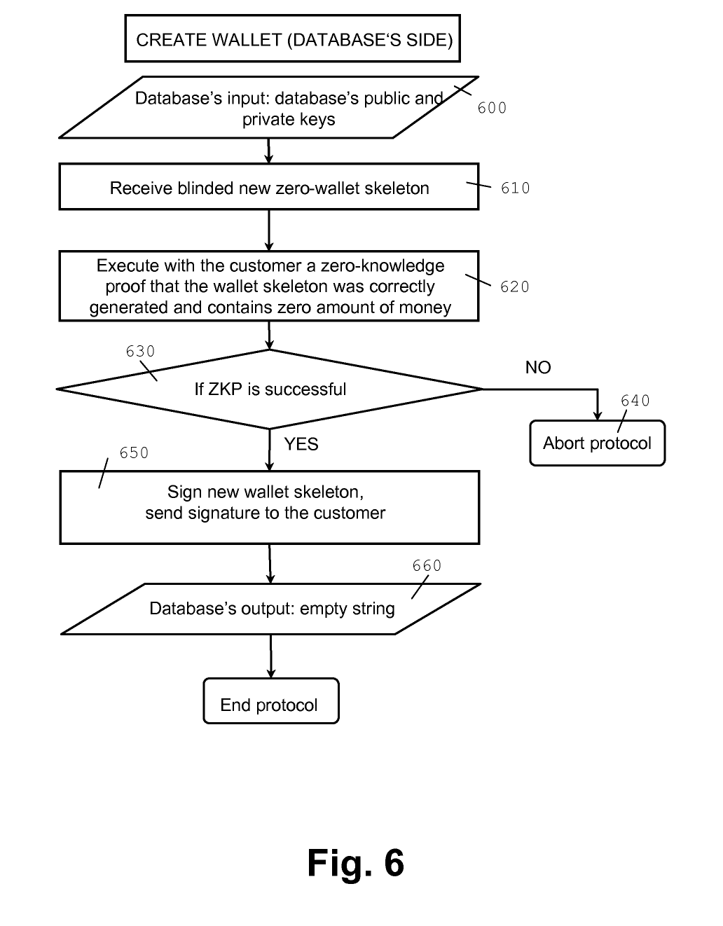

FIG. 6 shows an implementation of the database server side of the CreateWallet protocol. The public and private keys of the database server DB are used as input 600 in step 610, wherein the blinded new zero-wallet skeleton is received. Then a zero-knowledge proof that the wallet skeleton was correctly generated and contains zero amount of money is executed with the customer in step 520. In step 530 it will be determined if the zero-knowledge proof was successful. If not, then the protocol is aborted in step 540. Otherwise the new wallet skeleton is signed and the signature will be send to the customer in step 550. The protocol ends with an empty string 560 as the output of the database server DB.

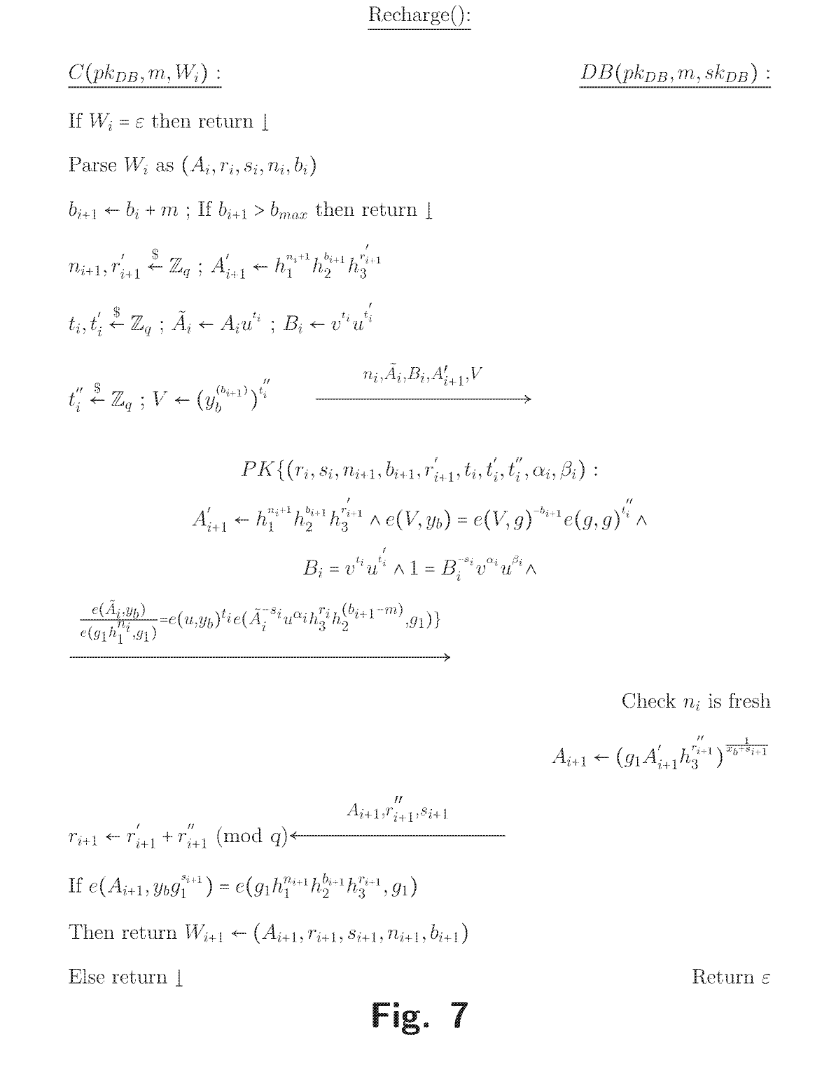

Customers can recharge the balance of their wallets by engaging in a Recharge protocol with the database server DB as shown in FIG. 7. Doing so does not reveal the remaining balance in the wallet obtained after purchasing a record. The common inputs are the public key pk_{DB} of the database server DB and the amount of money m that the customer wants to add to his balance. The secret key sk_{DB} of the database server DB and the customer's current wallet Wᵢ are private inputs to the database server DB and the customer, respectively. If the customer already obtained a wallet earlier (his state is not empty), he updates his balance to bᵢ₊₁=bᵢ+m and generates a fresh serial number nᵢ₊₁ and a randomizer for the new wallet. Then he chooses from the set of database signatures y_{b}⁽¹⁾, . . . , y_{b}^{(b}^{ₘₐₓ}⁾ of possible balances the signature corresponding to his new balance and blinds it as V=(y_{b}^{(B}^{ᵢ₊₁}⁾)^{t}^{ᵢ}^{″}. This allows him to prove that his new balance bᵢ₊₁ is positive and is less than bₘₐₓ using the set membership mentioned above.

Next the customer proves in zero-knowledge that he correctly increased his balance by the amount m being deposited. The database server DB checks if the serial number nᵢ is fresh, i.e., whether it previously saw the number nᵢ. If not, then the database server decides that the customer is trying to overspend and aborts. Otherwise, if the database server DB accepts the proof, it signs the customer's new wallet skeleton with updated balance and sends it to the customer. The customer checks the validity of the signature on her new wallet, and if it verifies correctly, outputs an updated state containing the new wallet Wᵢ₊₁.

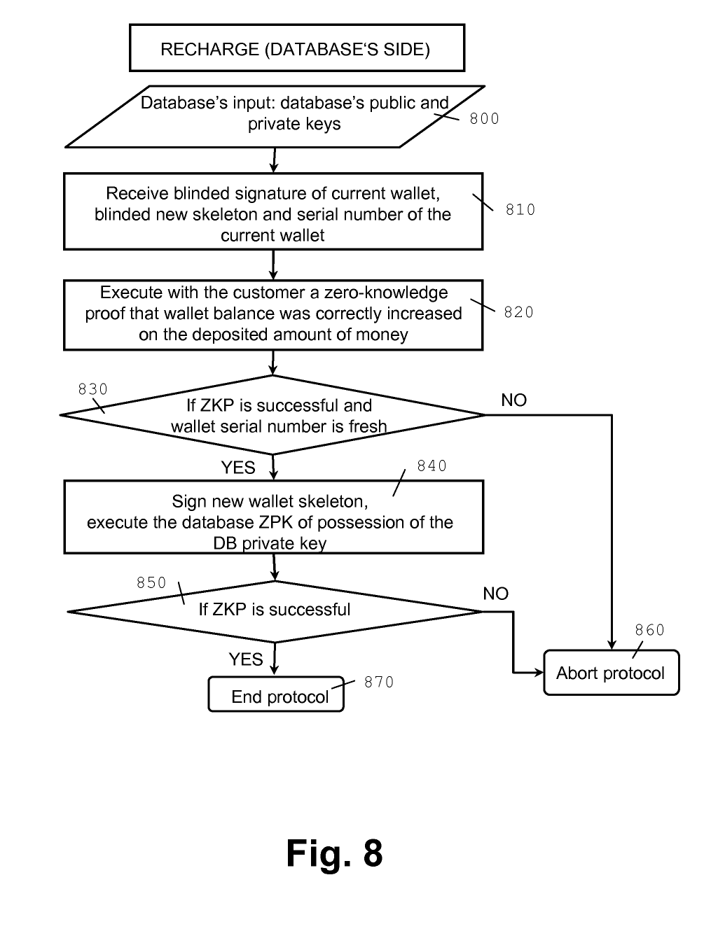

FIG. 8 shows an implementation of the database server side of the Recharge algorithm. The public and private keys of the database server DB are used as input 800. The blinded signature of the current wallet, the blinded new skeleton and serial number of the current wallet are received in step 810. Then a zero-knowledge proof that the wallet balance was correctly increased on the deposited amount of money is executed with the customer in step 820. In step 830 it will be determined if the zero-knowledge proof was successful and that the serial number is fresh. If not, then the protocol aborts in step 860. Otherwise the new wallet will be signed in step 840, followed by the zero-knowledge proof of the possession of the private key of the database server DB. In step 850 it will be determined if the zero-knowledge proof was successful. If not, then the protocol aborts in step 860. Otherwise the protocol ends in step 870.

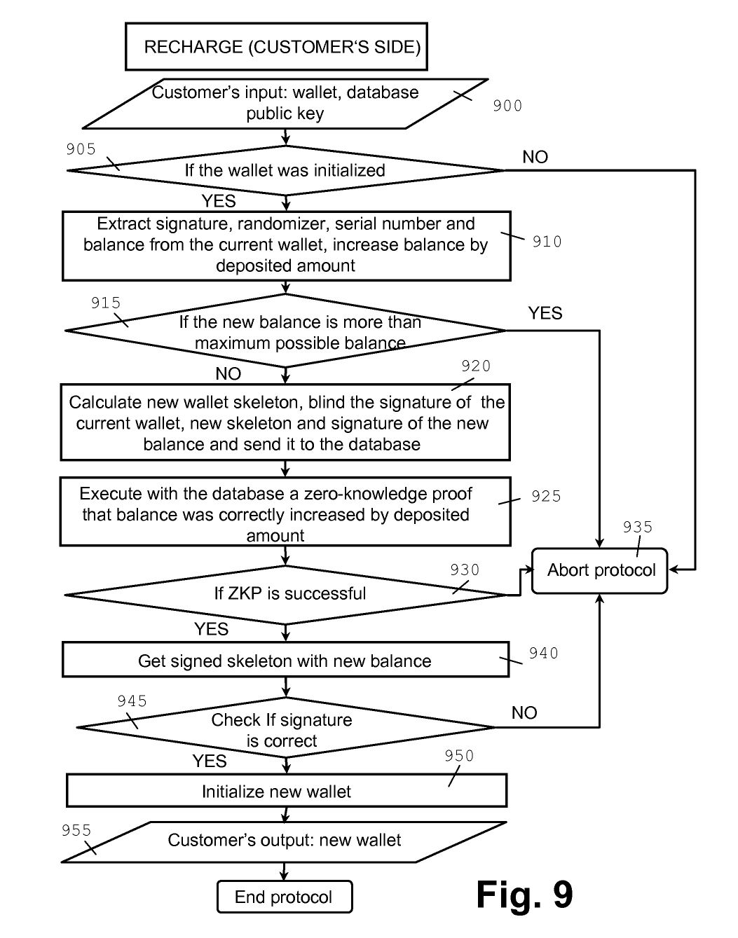

FIG. 9 shows an implementation of the customer side of the Recharge algorithm. The wallet, the public key of the database server DB are used as input 900 for step 905, where it will be determined if the wallet was initialized. If not, then the protocol aborts in step 935. Otherwise the signature, randomizer, serial number and balance of the current wallet are extracted from the current wallet in step 910, followed by an increase of the balance by the deposited amount. Then it will be determined in step 915 if the new balance is more than the maximum possible balance. If that is the case, then the protocol aborts in step 935. Otherwise the new wallet skeleton will be calculated in step 920, followed by a blinding of the signature of the new wallet, new skeleton and signature of the new balance, which will then be sent to the database server DB. A zero-knowledge proof that the balance was correctly increased by the deposited amount is then executed in step 925. In step 930 it will be determined if the zero-knowledge proof was successful. If not, then the protocol aborts in step 935. Otherwise the signed skeleton will be obtained in step 940. Then in step 945 it will be determined if the signature is correct. If not, then the protocol aborts in step 935. Otherwise the new wallet will be initialized in step 950, resulting in a new wallet 955.

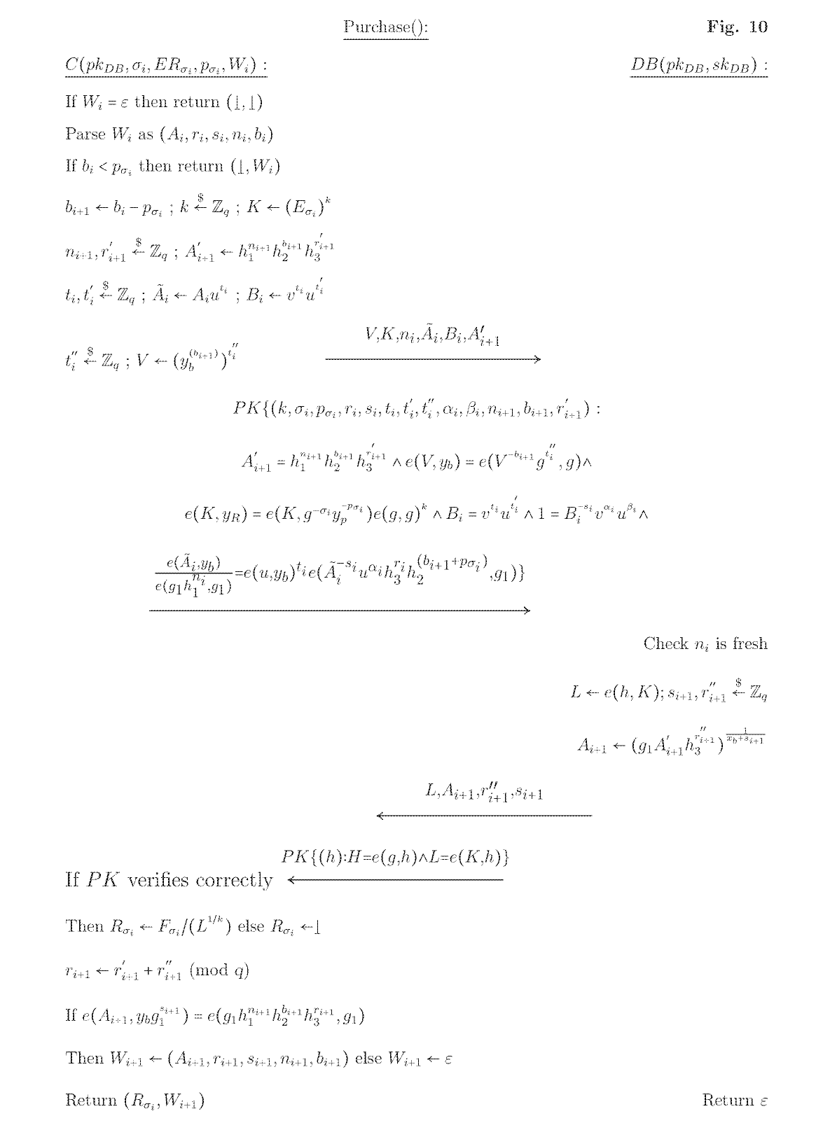

When the customer wants to purchase a record from the database server DB, he engages in a Purchase protocol with the database DB as shown in FIG. 10. The only common input is the public key pk_{DB} of the database server DB. The customer has as a private input her selection index σᵢ∈{1, . . . , N}, the encrypted record ER_{σ}_{ᵢ} and its price p_{σ}_{ᵢ}, and his current wallet Wᵢ. The database server DB uses its secret key as a private input sk_{DB}. The customer blinds the first part of the chosen encrypted record E_{σ}_{ᵢ} and sends this blinded version K to the database server DB. E_{σ}_{ᵢ} is derived from the secret key sk_{DB} of the database server DB, the index and the price of the record. Next, the customer updates his balance to bᵢ₊₁=bᵢ−p_{σ}_{ᵢ}, generates a fresh serial number nᵢ₊₁ and a randomizer for the new wallet. Then he chooses from the set of database signatures y_{b}⁽⁰⁾, . . . , y_{b}^{(b}^{ₘₐₓ}⁾ of possible balances the signature corresponding to his new balance and blinds it as V=(y_{b}^{(b}^{ᵢ₊₁}⁾)^{t}^{ᵢ}^{″}. This allows him to prove that his new balance bᵢ₊₁ is positive using the set membership scheme mentioned above.

Next the customer proves in zero-knowledge that K is correctly formed as blinding of some E_{σ}_{ᵢ}, and that he correctly reduced his balance by the price of the requested record. The database server DB checks if the serial number nᵢ is fresh, i.e., whether it previously saw the number nᵢ. If not, then the database server DB decides that the customer is trying to double-spend and aborts. Otherwise, if the database server DB accepts the proof, it computes L from h and K, sends L to the customer, and executes a proof of knowledge of the secret key h of the database server DB, and that L was computed correctly. Also the database server DB signs the customer's new wallet with updated balance and sends it to the customer. The customer checks the validity of the zero-knowledge proof and of the signature on his new wallet. If the wallet signature is invalid, then it returns ε as the new wallet; if all goes correctly, he outputs the record R_{σ} and new wallet Wᵢ₊₁. The protocol is easily seen to be correct by observing that L=e(h, E_{σ}_{ᵢ})^{k}, so therefore

$$\frac{{F}_{σ}}{{L}^{\frac{1}{k}}} = {R}_{{σ}_{i}} .$$

It should be noted that PK{(h):H=e(g, h) [symbol] L=e(K, h)} can be realized in the standard way as e(g,•) is a group (one-way) homomorphism that maps [symbol] into [symbol] _{T}.

It should also be noted that the database server DB has to calculate a signature of every element in the set of all possible balances in the customer's wallet {0, . . . , bₘₐₓ} and encrypt all records {1, . . . , N} only once at the setup phase, and the customer has to download the entire encrypted database and balance signatures only once as well. So the communication and computation complexity of the protocol depends on a cardinality of a set of all possible balances in the customer's wallet and a number of the records in the database only at the setup phase. The rest parts of the protocol (CreateWallet, Recharge and Purchase), however, require only a constant number of group elements to be sent and a constant number of exponentiations and pairings to be calculated.

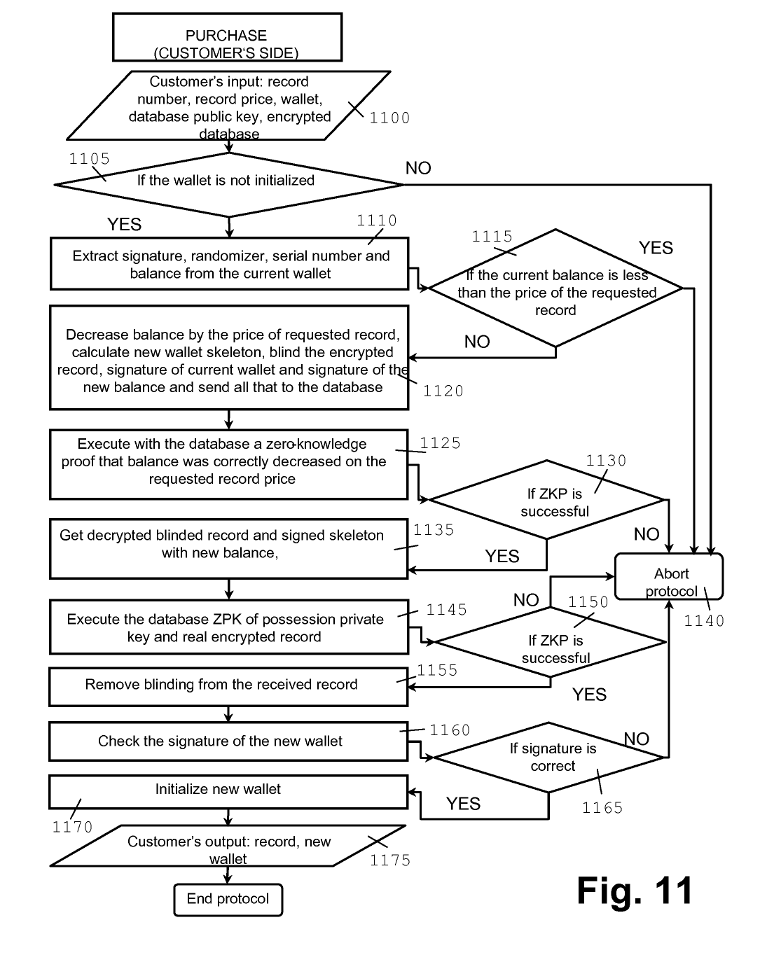

FIG. 11 shows an implementation of the customer side of the Purchase algorithm. The record number, record price, wallet, public key of the database server DB and the encrypted database are used as input 1100 for step 1105, wherein it will be determined if the wallet is not initialized. If not, then the protocol aborts in step 1140. Otherwise the signature, randomizer, serial number and balance from the current wallet are extracted in step 1110. Then it will be determined in step 1115 if the current balance is less than the price of the requested record. If so, then the protocol aborts in step 1140. Otherwise the balance is decreased by the price of the requested record, the new wallet skeleton is calculated, and the encrypted record, the signature of the current wallet, the new skeleton and the signature of the new balance are blinded and send to the database server DB in step 1120. Then a zero-knowledge proof that the balance was correctly decreased on the requested record price is performed in step 1125. It will be determined in step 1130 if the zero-knowledge proof was successful. If not, then the protocol aborts in step 1140. Otherwise the decrypted blinded record and the signed skeleton with new balance are obtained in step 1135. Then the zero-knowledge proof of the possession of the database's secret key is performed with the database server in step 1145. In step 1150 it will be determined if the zero-knowledge proof was successful. If not, then the protocol is aborted in step 1140. Otherwise the blinding is removed from the received record in step 1155. The signature of the new wallet is then checked in step 1160. Then it will be determined in step 1165 if the signature was correct. If not, then the protocol aborts in step 1140. Otherwise the new wallet will be initialized in step 1170, resulting in a new wallet and the decrypted record as output 1175.

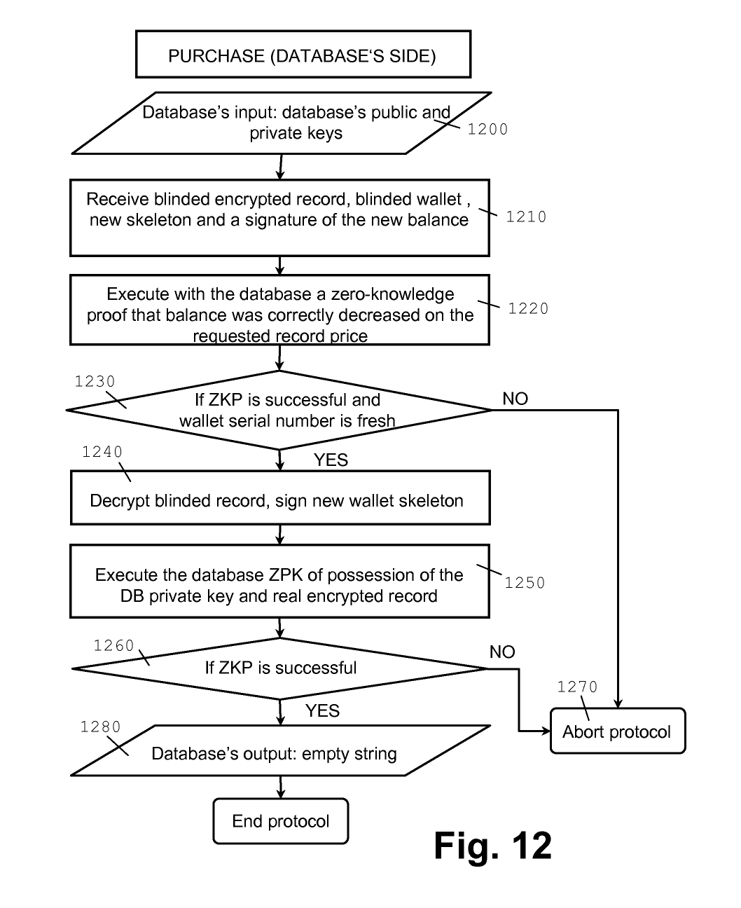

FIG. 12 shows an implementation of the database server side of the Purchase algorithm. The public and private keys of the database server DB are used as input 1200 for step 1210, wherein the blinded encrypted record, blinded wallet, new skeleton and a signature of the new balance are received. Then a zero-knowledge proof that the balance was correctly decreased on the requested record price is performed with the database server DB in step 1220. It will be determined in step 1230 if the zero-knowledge proof was successful and the wallet serial number is fresh. If not, then the protocol aborts in step 1270. Otherwise the blinded record will be decrypted and the new wallet skeleton will be signed in step 1240. In step 1250 a zero-knowledge proof of possession of the private key of the database server and the real encrypted record is performed with the customer. It will be determined in step 1260 if the zero-knowledge proof was successful. If not, then the protocol aborts in step 1270. The protocol ends with an empty string 1280 as the output of the database server DB.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium.

More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

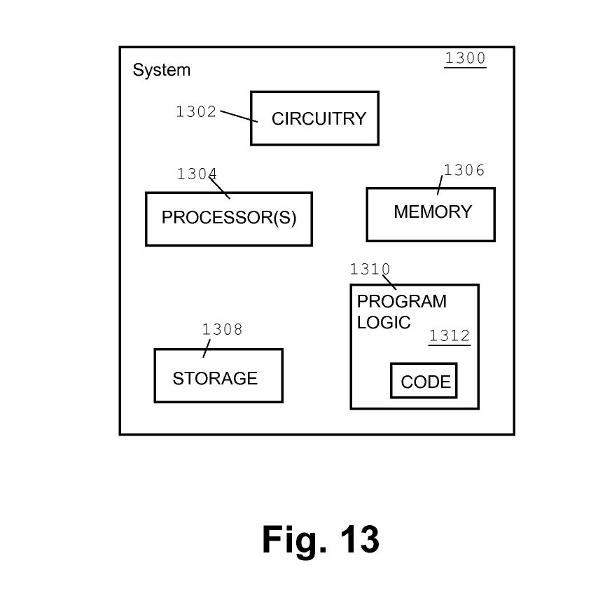

FIG. 13 illustrates a block diagram of a computer system 1300 in which certain embodiments may be implemented. The system 1300 may include a circuitry 1302 that may in certain embodiments include a microprocessor 1304. The computer system 1300 may also include a memory 1306 (e.g., a volatile memory device), and storage 1308. The storage 1308 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 1308 may comprise an internal storage device, an attached storage device and/or a network accessible storage device. The system 1300 may include a program logic 1310 including code 1312 that may be loaded into the memory 1306 and executed by the microprocessor 1304 or circuitry 1302. In certain embodiments, the program logic 1310 including code 1312 may be stored in the storage 1308. In certain other embodiments, the program logic 1310 may be implemented in the circuitry 1302. Therefore, while FIG. 13 shows the program logic 1310 separately from the other elements, the program logic 1310 may be implemented in the memory 1306 and/or the circuitry 1302.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A computer system comprising:
at least one processor;
a memory;
a server program embodied as instructions storable in the memory and executable on said at least one processor, the server program allowing each of a plurality of customers to anonymously purchase respective records from a database, said database comprising a plurality of records, each record having a respective index and respective purchase price, wherein an encrypted form of said database is published and available to purchasers of selective records of said database, each record contained in the encrypted form of said database being encrypted with a respective record encryption key derived from the respective index of the database record and purchase price of the respective database record;
wherein the server program is configured to receive a plurality of purchase requests, each on behalf of respective customer, to purchase a respective database record contained in said database, each said purchase request comprising a respective blinded encrypted requested database record and a respective blinded wallet data structure, the respective wallet data structure being associated with a respective a new balance corresponding to the respective purchase request;
wherein responsive to each said purchase request, the server program, without having access to the identity of the respective requested database record, the purchase price of the respective requested database record, the identity of the respective customer, or the new balance corresponding to the respective purchase request:
(a) verifies that the new balance corresponding to the respective purchase request was correctly determined according to the purchase price of the respective requested database record;
(b) responsive to verifying that the new balance corresponding to the respective purchase request was correctly determined, decrypts the respective blinded encrypted requested database record to produce a respective blinded unencrypted requested database record; and
(c) returns the respective blinded unencrypted requested database record as a response to the respective purchase request.

2. The computer system of claim 1, wherein responsive to each said purchase request, the server program, without having access to the identity of the respective requested database record, the purchase price of the respective requested database record, the identity of the respective customer, or the new balance corresponding to the respective purchase request, further:
(d) generates a signature for the respective wallet data structure; and
(e) returns the signature for the respective wallet data structure as a response to the respective purchase request.

3. The computer system of claim 2, wherein the server program decrypts the respective blinded encrypted requested database record using a signature-based set membership protocol for the respective wallet balance with the respective customer.

4. The computer system of claim 1, wherein the server program verifies that the new balance corresponding to the respective purchase request was correctly determined by executing a zero knowledge proof in conjunction with the respective customer.

5. The computer system of claim 1, wherein each said wallet data structure comprises a respective current wallet signature, a respective new wallet skeleton, and a respective signature of the new balance corresponding to the respective purchase request.

6. The computer system of claim 1, wherein the respective record encryption key is further derived from a secret key of said computer system.

7. The computer system of claim 1,
wherein said server program is further configured to receive a plurality of wallet recharge requests, each said wallet recharge request on behalf of a respective customer and comprising a respective blinded wallet data structure, the respective blinded wallet data structure having a new balance corresponding to the respective wallet recharge request;
wherein responsive to each said wallet recharge request, the server program, without having access to the identity of the identity of the respective customer or the new balance corresponding to the respective wallet recharge request:
(a) verifies that the new balance corresponding to the respective wallet recharge request was correctly increased by a respective deposited amount;
(b) responsive to verifying that the new balance corresponding to the wallet recharge request was correctly increased, generates a signature for the respective wallet data structure; and
(c) returns the signature for the respective wallet data structure as a response to the respective wallet recharge request;
wherein the method is performed without revealing to said server computer system the identity of the requested database record, the identity of the customer, or the new balance corresponding to the wallet recharge request.

8. The computer system of claim 7, further comprising:
wherein said server program is further configured to receive a plurality of wallet registration requests, each said wallet registration request on behalf of a respective customer; wherein responsive to each said wallet registration request, the server program registers an empty wallet.

9. A computer program product recorded on a non-transitory computer-readable medium, the computer program product being executable on at least one computer system and causing the at least one computer system to function as a server, the server allowing each of a plurality of customers to anonymously purchase respective records from a database, said database comprising a plurality of records, each record having a respective index and respective purchase price, wherein an encrypted form of said database is published and available to purchasers of selective records of said database, each record contained in the encrypted form of said database being encrypted with a respective record encryption key derived from the respective index of the database record and purchase price of the respective database record;
wherein the server is configured to receive a plurality of purchase requests, each on behalf of respective customer, to purchase a respective database record contained in said database, each said purchase request comprising a respective blinded encrypted requested database record and a respective blinded wallet data structure, the respective wallet data structure being associated with a respective a new balance corresponding to the respective purchase request;
wherein responsive to each said purchase request, the server, without having access to the identity of the respective requested database record, the purchase price of the respective requested database record, the identity of the respective customer, or the new balance corresponding to the respective purchase request:
(a) verifies that the new balance corresponding to the respective purchase request was correctly determined according to the purchase price of the respective requested database record;
(b) responsive to verifying that the new balance corresponding to the respective purchase request was correctly determined, decrypts the respective blinded encrypted requested database record to produce a respective blinded unencrypted requested database record; and
(c) returns the respective blinded unencrypted requested database record as a response to the respective purchase request.

10. The computer program product of claim 9, wherein responsive to each said purchase request, the server, without having access to the identity of the respective requested database record, the purchase price of the respective requested database record, the identity of the respective customer, or the new balance corresponding to the respective purchase request, further:
(d) generates a signature for the respective wallet data structure; and
(e) returns the signature for the respective wallet data structure as a response to the respective purchase request.

11. The computer program product of claim 10, wherein the server decrypts the respective blinded encrypted requested database record using a signature-based set membership protocol for the respective wallet balance with the respective customer.

12. The computer program product of claim 9, wherein the server verifies that the new balance corresponding to the respective purchase request was correctly determined by executing a zero knowledge proof in conjunction with the respective customer.

13. The computer program product of claim 9, wherein each said wallet data structure comprises a respective current wallet signature, a respective new wallet skeleton, and a respective signature of the new balance corresponding to the respective purchase request.

14. The computer program product of claim 9, wherein the respective record encryption key is further derived from a secret key of said server.

15. The computer program product of claim 9,
wherein said server is further configured to receive a plurality of wallet recharge requests, each said wallet recharge request on behalf of a respective customer and comprising a respective blinded wallet data structure, the respective blinded wallet data structure having a new balance corresponding to the respective wallet recharge request;
wherein responsive to each said wallet recharge request, the server, without having access to the identity of the identity of the respective customer or the new balance corresponding to the respective wallet recharge request:
(a) verifies that the new balance corresponding to the respective wallet recharge request was correctly increased by a respective deposited amount;
(b) responsive to verifying that the new balance corresponding to the wallet recharge request was correctly increased, generates a signature for the respective wallet data structure; and
(c) returns the signature for the respective wallet data structure as a response to the respective wallet recharge request;
wherein the method is performed without revealing to said server the identity of the requested database record, the identity of the customer, or the new balance corresponding to the wallet recharge request.

16. The computer program product of claim 15, further comprising:
wherein said server is further configured to receive a plurality of wallet registration requests, each said wallet registration request on behalf of a respective customer; wherein responsive to each said wallet registration request, the server registers an empty wallet.
